(19) United States
(12) Patent Application Publication
(10) Pub. No.: US 2024/0043601 A1
(43) Pub. Date: Feb. 8, 2024

(54) CROSS-LINKED ORGANOSILICON NETWORKS THAT DEGRADE WITH FLUORIDE SALTS

(71) Applicant: The Government of the United States of America, as represented by the Secretary of the Navy, Arlington, VA (US)

(72) Inventors: Erick B. Iezzi, Mars, PA (US); Keith B. Sutyak, Richmond, VA (US); Grant C. Daniels, Burke, VA (US); Eugene Camerino, Powhatan, VA (US)

(73) Assignee: The Government of the United States of America, as represented by the Secretary of the Navy, Arlington, VA (US)

(21) Appl. No.: 18/354,764

(22) Filed: Jul. 19, 2023

Related U.S. Application Data
(60) Provisional application No. 63/392,722, filed on Jul. 27, 2022.

(51) Int. Cl. C08G 18/38; C08G 18/10; C08G 18/30; C08K 5/544; C09D 183/08; C09D 9/00; C08K 5/19; C08K 3/16

(52) U.S. Cl. CPC C08G 18/3893; C08G 18/10; C08G 18/307; C08K 5/544; C09D 183/08; C09D 9/005; C08K 5/19; C08K 3/16; C08G 2150/00

(57) ABSTRACT

Disclosed herein is a method and thermoset made by: reacting a di- or tri-functional isocyanate with a silyl-containing compound to form a polyurethane having at least one unreacted isocyanate group, reacting the polyurethane with an aminoalkylalkoxysilane to form an alkoxysilane-terminated polyurethane, and moisture-curing the alkoxysilane-terminated polyurethane to form the thermoset. The silyl-containing compound has the formula: SiR¹ₙ[R³—(O—CO—X—R³)ₘ—OH]₄₋ₙ. Each X is —O— or —NR²—; each R¹ is an alkyl group or an aryl group; each R² is —H, an alkyl group, or an aryl group; each R³ is an alkylene group; n is 0, 1, or 2; and each m is a non-negative integer. The thermoset may be degraded by treatment with a solution of a fluoride salt in an organic solvent.

This application claims the benefit of U.S. Provisional Application No. 63/392,722, filed on Jul. 27, 2022. The provisional application and all other publications and patent documents referred to throughout this nonprovisional application are incorporated herein by reference.

### TECHNICAL FIELD

The present disclosure is generally related to silyl-containing cross-linked networks

### DESCRIPTION OF RELATED ART

Cross-linked organosilicon networks are hybrid polymeric materials that possess both silicon-oxygen (Si—O) and silicon-carbon (Si—C) bonds. These materials provide excellent resistance to moisture, hydrocarbons, and photo-oxidation from sunlight, including increased thermal stability and flammability compared to networks composed of all hydrocarbon linkages. The unique properties of organosilicon networks have led to their application in a wide range of consumer and industrial products, such as construction sealants, cooking utensils, automotive adhesives, dental moldings, and roof coatings. Organosilicon networks are used to engender high-performance coatings that are anti-corrosive, cleanable, and both color and gloss retentive for use in the protective and marine market (e.g., the exterior topsides (above the waterline) of surface ships). These coatings, commonly referred to as polysiloxanes, are produced by several manufacturers and are qualified to MIL-PRF-24635 performance requirements for Navy surface ships.

Polysiloxane coatings for Navy surface ships are supplied as either a single- (1K) or two-component (2K) systems. The former, which is based on organosilane polymers, is an all-in-one-can system that does not require the metering and mixing of components. Upon application, the organosilane polymers hydrolyze with moisture and condense to form a cross-linked network with siloxane (Si—O—Si) linkages. Two-component polysiloxane coatings, which are formed by the dual reaction of epoxy-functional oligomers or acrylate-functional oligomers with 3-aminopropyltrialkoxysilanes, require the metering and mixing of components to form the cross-linked network. Two-component systems require less solvent and hence volatile organic compounds (VOCs), due to the low viscosity nature of the molecular components, whereas the single-component systems provide a longer pot-life and reduce the generation of hazardous paint waste.

The covalent Si—O bonds and tangled polymeric chains in cross-linked organosilicon networks prevents them from being easily solvated, heated and reformed, or recycled. The covalent bonds and tangled chains also render these networks difficult to degrade and/or remove from a surface, such as when a ship topside repainting is required, without using hazardous chemical treatments (e.g., methylene chloride), mechanical abrasion (e.g., abrasive blast media, sand paper), or thermal ablation (e.g., lasers). However, all of these removal methods are non-selective for the organosilicon network and will also damage the underlying polymeric (e.g., anti-corrosive primer, fiber-reinforced composite) or mixed-metal substrate. To date, a cross-linked and high-performance organosilicon network that can be selectively activated and degraded with a mild chemical treatment, and without damaging the underling substrate, has not been realized.

### BRIEF SUMMARY

Disclosed herein is a method comprising: reacting a di- or tri-isocyanate with a silyl-containing compound to form a polyurethane having at least one unreacted isocyanate group, reacting the polyurethane with an aminoalkylalkoxysilane to form an alkoxysilane-terminated polyurethane, and moisture-curing the alkoxysilane-terminated polyurethane to form the thermoset. The silyl-containing compound has the formula: SiR¹ₙ[R³—(O—CO—X—R³)ₘ—OH]₄₋ₙ. Each X is independently selected from —O— and —NR²—; each R¹ is independently selected from alkyl groups and aryl groups; each R² is independently selected from —H, alkyl groups, and aryl groups; each R³ is an independently selected alkylene group; n is 0, 1, or 2; and each m is an independently selected non-negative integer.

Also disclosed herein is a thermoset made by the above method.

### BRIEF DESCRIPTION OF THE DRAWINGS

A more complete appreciation will be readily obtained by reference to the following Description of the Example Embodiments and the accompanying drawings.

FIG. 1 shows the Synthesis of (diphenylsilanediyl)bis(ethane-2,1-diyl) bis((2-(((2-hydroxyethyl)(methyl)carbamoyl)oxy)ethyl)(methyl)carbamate) 3 from 2,2′-(diphenylsilanediyl)bis(ethan-1-ol) 1.

FIG. 2 shows synthesis of a generic moisture-curable organosilane polymer 6 with silyl and N-methyl carbamate linkages.

FIG. 3 shows synthesis of a generic cross-linked organosilicon network 7 based on an organosilane polymer 6.

FIG. 4 shows fluoride-initiated partial degradation of an aliphatic chain within the cross-linked organosilicon network.

FIG. 5 shows a photograph demonstating 5A X-cut adhesion rating of cross-linked organosilicon network over epoxy primer

FIG. 6A shows a photograph demonstating complete removal of organosilicon coating via TBAF solution and without damaging the underlying black epoxy primer, FIG. 6B shows minor surface degradation to a commercial 2K organosilicon (polysiloxane) coating upon treatment with a TBAF solution for the same time period. The circles indicate the area of exposure.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted to not obscure the present disclosure with unnecessary detail.

Disclosed herein are molecular compositions and methods for forming cross-linked organosilicon networks that can be degraded and selectively removed from a substrate when activated with fluoride ion from a fluoride salt. The technology is based on organosilane molecules, such as polymers, which contain a silyl-centered group (i.e., chemical trigger) with two to four aliphatic appendages, in addition to alkoxysilane groups at the terminus of the molecule. These alkoxysilane groups hydrolyze with atmospheric moisture to form silanol linkages, which subsequently condense to form siloxane linkages and the cross-linked organosilicon network.

The thermosets are made starting from a silyl-containing compound having the formula: SiR¹ₙ[R³—(O—CO—X—R³)ₘ—OH]₄₋ₙ. Each X is independently selected from —O— and —NR²—; each R¹ is independently selected from alkyl groups and aryl groups; each R² is independently selected from —H, alkyl groups, and aryl groups; each R³ is an independently selected alkylene group; n is 0, 1, or 2; and each m is an independently selected non-negative integer. One example silyl-containing compound is shown below.

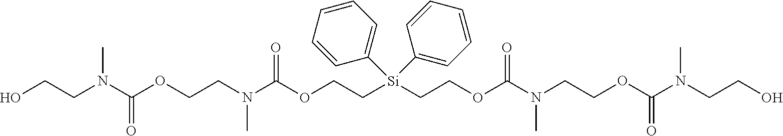 [SMILES: CN(CCO)C(=O)OCCN(C)C(=O)OCC[Si](CCOC(=O)N(C)CCOC(=O)N(C)CCO)(c1ccccc1)c1ccccc1]

The silyl-containing compound is reacted with a di- or tri-functional isocyanate to form a polyurethane. As used herein, a polyisocyanate is a compound having at least two isocyanate groups. Suitable di- or tri-functional isocyanates include, but are not limited to, hexamethylene diisocyanate, toluene diisocyanate, methylene diphenyl diisocyanate, including derivatives of hexamethylene diisocyanate, such as a uretdione, a biuret, or an isocyanurate. The polyurethane has at least one unreacted isocyanate group.

The unreacted isocyanate group(s) of the polyurethane are then reacted with an aminoalkylalkoxysilane to form an alkoxysilane-terminated polyurethane. Suitable aminoalkylalkoxysilanes include, but are not limited to, N-butyl-3-aminopropyltrimethoxysilane, N-butyl-3-aminopropylmethyldimethoxysilane, and N-cyclohexyl-1-aminomethyltriethoxysilane.

The alkoxysilane-terminated polyurethane is then moisture-cured to form the thermoset as described above. The thermoset may be applied to a surface as a coating.

When removal of the coating is desired, it may be treated with a solution of a fluoride salt in an organic solvent. This has the effect of cleaving at least some silicon-carbon and silicon-oxygen bonds in the thermoset, degrading the coating and making it easily removable. Suitable fluoride salts include, but are not limited to, tetrabutylammonium fluoride, tetrabutylammonium difluorotriphenylsilicate, and cesium fluoride.

The degradation can cause the release of ethylene and carbon dioxide, as well as 3-methyl-2-oxazolidinone in the case of carbamates (X is —NR²—) or ethylene carbonate in the case of carbonates (X is —O—).

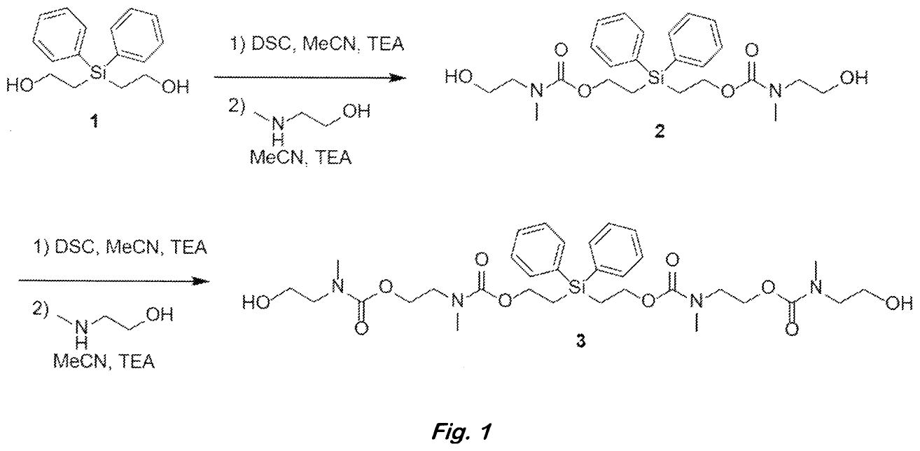

The appendages that radiate from the silyl center may comprise carbamate, carbonate, linear hydrocarbon, and other aliphatic-based linkages, whereas the alkoxysilane groups may be trimethoxysilane, triethoxysilane, methyldimethoxysilane, or methyldiethoxysilane. FIG. 1 provides an example synthesis of a silyl-centered diol with two appendages and four N-methyl carbamate linkages.

The silyl-centered hydroxyl-functional starting material can possess a variety of compositions. For example, the silyl group can be bound to aliphatic and aromatic groups, whereas the hydroxyl-functional appendage can be an ethylene, propylene, or butylene group. The silyl starting material can also possess di-, tri- and tetra-hydroxyl functionality as shown by the equation SiR¹ₙ[(CH₂)₂₋₄OH]₄₋ₙ. The value n is 0, 1, or 2 and R is an alkyl or aryl group.

As shown in FIG. 1, larger silyl-containing molecules with hydroxyl-functionality and carbamate and/or carbonate groups can be synthesized from the small molecule silyl-centered starting material. The purpose of the additional linkages is to provide a greater number of cleavable bonds in the organosilicon network, including providing the ability to tune network mechanical and thermal properties.

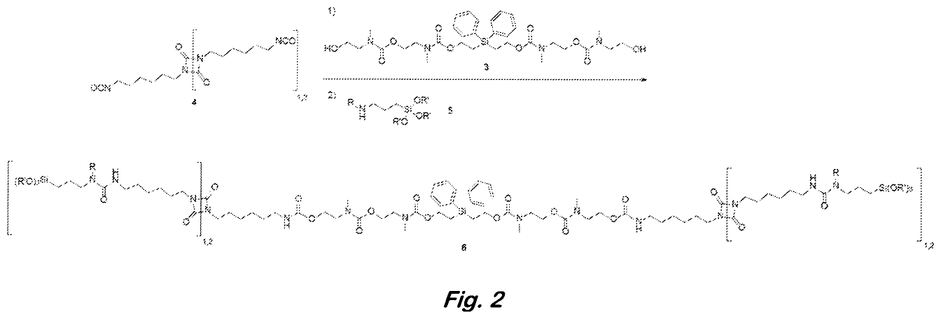

FIG. 2 provides an example synthesis of a moisture-curable organosilane polymer with silyl and four N-methyl carbamate linkages. This polymer can be synthesized by reacting a di- or tri-functional isocyanate with the silyl-centered diol 3 in FIG. 1, followed by reaction of the remaining isocyanate groups with N-alkyl-3-aminopropyltrialkoxysilane. The isocyanate can be aliphatic, cycloaliphatic, or aromatic. The isocyanate may also be a pre-polymer that contains ester or ether linkages. The alkyl groups of N-alkyl-3-aminopropyltrialkoxysilane can be aliphatic (e.g., methyl, butyl, isopropyl) or cycloaliphatic, whereas the trialkoxysilane group can be trimethoxy or triethoxy. Alternative aminoalkylalkoxysilanes, such as N-cyclohexyl-1-aminomethyltriethoxysilane, can be utilized to tune the degree of hydrogen bonding. The organosilane polymer may comprise at least 5 wt. % of a silyl-containing diol.

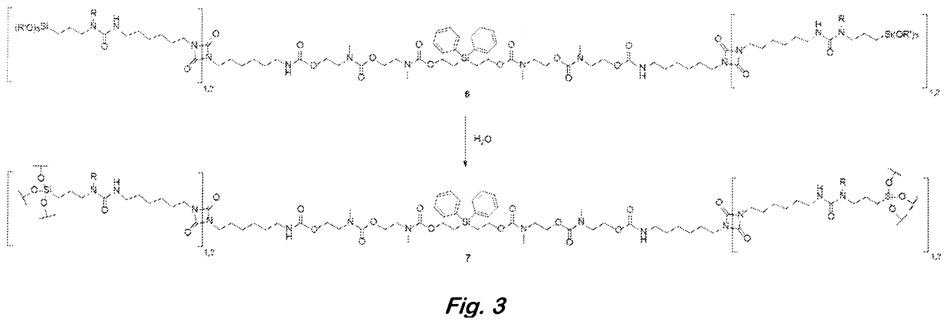

FIG. 3 provides an example of a cross-linked organosilicon network based on a moisture-curable organosilane polymer with silyl and N-methyl carbamate linkages. The organosilane polymer composition can be unfilled (i.e., clear) or filled (i.e., colorizing pigments, extenders, matting agents), may contain solvents, additives, and a catalyst, and can be applied via spray, brush, roll, trowel, or dip methods. Atmospheric moisture is required for the organosilane network to hydrolyze and cross-link.

The organosilicon networks can be degraded at room temperature upon activation with fluoride ion from a fluoride salt. The salt can be in the form of a solution, gel, paste, or as a neat chemical composition. Example salt solutions include a 1.0 molar (M) solution of tetrabutylammonium fluoride (TBAF) in tetrahydrofuran (THF), TBAF in propylene glycol monomethyl ether acetate (PM Acetate), and TBAF in diethylene glycol monoethyl ether acetate (DEGMEA). Alternative fluoride sources, such as cesium fluoride (CsF), may also be utilized. If necessary, thickeners, such as hydroxypropyl methylcellulose or polyamide waxes, can be added to the fluoride salt composition to increase viscosity and/or tailor thixotropic properties. Corrosion inhibitors and other additives can also be added to the fluoride salt composition.

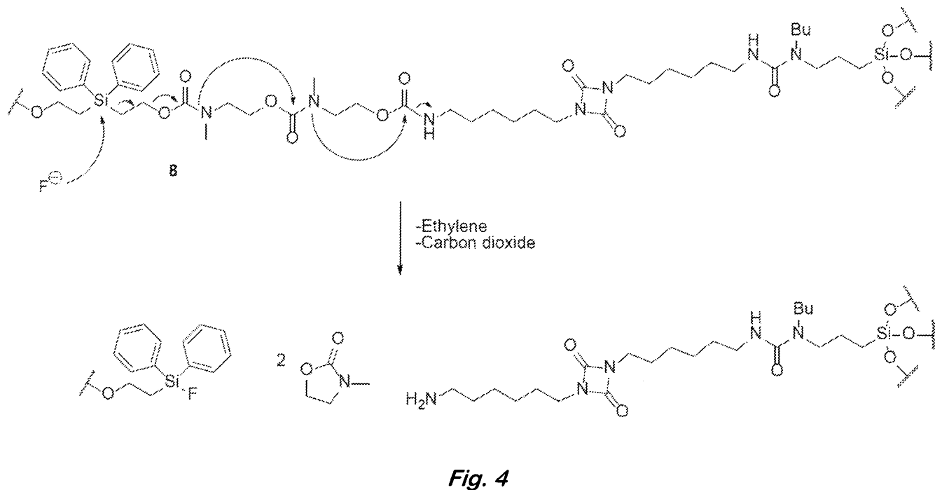

Treatment of the organosilicon network with a fluoride salt, whether immersed in solution or via topical application, results in activation of the silyl trigger via cleavage of the Si—C bonds. This is followed by cascading bond cleavages and the release of various small molecules. The disassembly of polymer chains results in a loss of network integrity and the complete degradation of the cross-linked organosilicon material. Because the material is degraded, it can be easily removed from an underlying and strongly adhered substrate (e.g., epoxy primer) via wiping with a cloth or rinsing with a solvent (e.g., acetone). FIG. 4 provides an example of network chain disassembly upon reaction of fluoride ion at the silyl trigger. During this entropically-favored process, small molecules, such as ethylene (gas) and 3-methyl-2-oxazolidinone (liquid), are generated. Several of the siloxane linkages within the network may also be cleaved with fluoride ion to aid with degradation.

Organosilicon networks that do not possess chains with a silyl linkage and disassemble via cascading bond cleavages will not readily degrade with a fluoride salt. As shown in Example 5, this was proven by treatment of a commercial semi-gloss gray 2K organosilicon (a.k.a. polysiloxane) coating with 1.0 M TBAF (DEGMEA), which resulted in only minute surface degradation to the coating after 13 hours of topical exposure.

As discussed above, commercial organosilicon networks do not possess the ability to easily degrade, nor can they be selectively removed from an underlying substrate without damaging said substrate. The cross-linked organosilicon networks disclosed herein can provide similar properties as legacy (i.e., non-degradable) organosilicons, yet selectively degrade when activated with fluoride ion from a fluoride salt composition.

Potential applications for these degradable organosilicon networks include: 1) easy removal of topside coatings on surface ships, 2) selective removal of coatings from sensitive composite substrates, such as those with critical radio frequency tolerance, and 3) facile removal of bandages or adhesives.

The following examples are given to illustrate specific applications. These specific examples are not intended to limit the scope of the disclosure in this application.

### Example 1

Synthesis of (diphenylsilanediyl)bis(ethane-2,1-diyl) bis((2-hydroxyethyl) (methyl)carbamate) 2-Triethylamine (Sigma-Aldrich, 1.02 mL, 7.34 mmol) was added to 2,2′-(diphenylsilanediyl)bis(ethan-1-ol) 1 (0.52 mg, 1.83 mmol) in 100 mL acetonitrile, followed by the addition of N,N′-disuccinimidyl carbonate (DSC) (Sigma-Aldrich, 0.9 g, 3.67 mmol). The reaction was stirred overnight at room temperature. The reaction was then concentrated and extracted using ethyl acetate (100 mL) and saturated sodium bicarbonate (50 mL). The organic layer was concentrated after dried over magnesium sulfate. The resulting mixture produced a precipitate and was filtered with ethyl acetate to furnish bis(2,5-dioxopyrrolidin-1-yl) ((diphenylsilanediyl)bis(ethane-2,1-diyl)) bis(carbonate) (0.4 g) as a white powder in 40% yield.

A solution of N-methylethanolamine (Sigma-Aldrich, 2.0 mL, 31.4 mmol) and triethylamine (4.1 mL, 29.4 mmol) was prepared in acetonitrile (60 mL). Bis(2,5-dioxopyrrolidin-1-yl) ((diphenylsilanediyl)bis(ethane-2,1-diyl)) bis(carbonate) (6.5 g, 11.7 mmol) was then added to the solution and was stirred overnight at room temperature. The reaction mixture was concentrated, dissolved in dichloromethane, and washed with sodium bicarbonate, 3.0 M sodium hydroxide, and brine. The organic layer was dried over magnesium sulfate and concentrated under reduced pressure. The resulting mixture was purified using column chromatography (95:5 dichloromethane:methanol) to furnish the desired product 2 as a clear liquid (2.8 g, 51% yield).

### Example 2

Synthesis of (diphenylsilanediyl)bis(ethane-2,1-diyl) bis((2-(((2-hydroxyethyl)(methyl) carbamoyl)oxy)ethyl)(methyl)carbamate) 3-(Diphenylsilanediyl)bis(ethane-2,1-diyl) bis((2-hydroxyethyl)(methyl)carbamate) 2 (9.98 g, 42.0 mmol) and triethylamine (34.0 mL, 243.9 mmol) were added to a 500-mL round bottom flask containing 200 mL dry acetonitrile. N,N′-disuccinimidyl carbonate (42.5 g, 165.9 mmol) was then added to the flask with a stir bar and allowed to stir for 16 hours at room temperature. Thin layer chromatography (TLC) was used to determine the reaction had progressed to completion. The reaction mixture was then concentrated in vacuo to afford a yellow liquid. The liquid was dissolved in chloroform (200 mL) and washed with brine (3×50 mL). The organic layer was concentrated in vacuo to afford a yellow liquid.

The liquid was dissolved in acetonitrile (200 mL). Triethylamine (29.3 mL, 210.0 mmol) was added to the flask, followed by N-methylethanolamine (13.5 mL, 168.0 mmol). The reaction mixture was stirred at room temperature for 16 hours. TLC was used to determine reaction completion. The mixture was concentrated in vacuo to afford a yellow oil. Purification by column chromatography (9:1 CH₂Cl₂:CH₃OH) afforded the desired product 3 as a clear, yellow/orange oil (8.8 grams, 72.6% yield).

### Example 3

Synthesis of moisture-curable organosilane polymer with N-butyl urea, silyl, and N-methyl carbamate linkages 8-An aliphatic isocyanate based on hexamethylene diisocyanate (Desmodur N-3400 from Covestro, 47.5 g, 0.246 equiv.) was added to a round bottom flask, followed by butyl acetate (Sigma-Aldrich, 38.99 g). Vinyltrimethoxysilane (Gelest, 2.76 g) was added as a drying agent and the solution was blanketed with dry nitrogen. The solution was then stirred and heated to 50-60° C., followed by the addition of a 10 wt. % solution (1.25 g) of dibutyltin dilaurate (DBTDL, Sigma-Aldrich) in butyl acetate. Next, synthesized (diphenylsilanediyl)bis(ethane-2,1-diyl) bis((2-(((2-hydroxyethyl)(methyl)carbamoyl)oxy)ethyl)(methyl)carbamate) 3 (25 g, 0.0739 equiv.) was added dropwise to the solution while keeping the temperature below 70° C., followed by stirring at about 60° C. for 1 hour after the addition was complete. The heat was then removed, and N-buty-3-aminopropyltrimethoxysilane (Gelest, 40.48 g, 0.172 equiv.) was added dropwise, followed by stirring for 15 minutes after the addition was complete. Complete consumption of isocyanate groups was determined with Fourier Transform infrared spectroscopy (FT-IR). The organosilane polymer 8 solution was 75 wt. % solids with a density of 9.79 pounds per gallon.

### Example 4

Formation and properties of cross-linked organosilicon network—The organosilane polymer 8 from Example 3 (133.33 g solution, 100.0 g of polymer solids) was mixed with Chroma-Chem UCD 1060PS white tint paste (Chromaflo Technologies, 75.0 g) and butyl acetate (25.0 g) in a plastic cup. This was followed by the addition of C-11 ketone (Eastman, 5.0 g), butyl acetate (10.0 g), and a 10 wt.% solution (2.5 g) of dibutyltin dilaurate in butyl acetate. The mixture was then applied with high-volume, low-pressure (HVLP) spray equipment onto 3×6×0.010-inch tinplate steel panels (DT-36 from Q-Lab Corporation) and 3×6×0.025-inch chromated aluminum panels (AL-36 from Q-Lab Corporation), in addition to AL-36 panels that were coated with about 1.0 mil (˜25.4 microns) of a black epoxy primer (44GN008A from PPG/Deft). The mixture was sprayed to generate white-colored coatings with a wet film thickness (WFT) of 3-4 mils (76.2-101.6 microns). The applied material was then allowed to react under laboratory conditions (68-72° F., 40-60% relative humidity) for 14 days to form a white cross-linked organosilicon network, in the form of a coating, with a dry film thickness (DFT) of 1.6-2.4 mils (40.6-60.9 microns) and a semi-gloss (56.6 gloss units at 60 degree angle) finish.

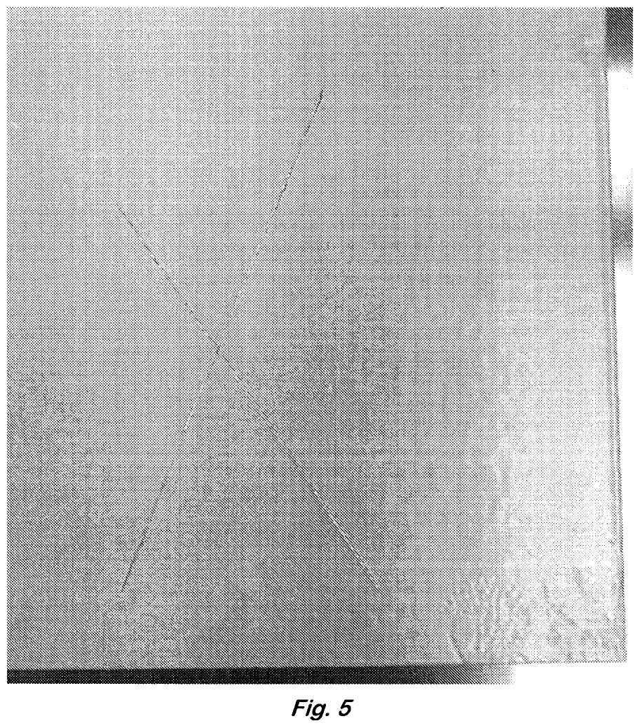

The cross-linked organosilicon network possessed a König pendulum hardness of 38 oscillations, showed no surface marring when subjected to 100 double rubs with a methyl ethyl ketone (MEK) soaked rag, and passed a 0.25-inch cylindrical mandrel bend without cracking. In addition, as shown in FIG. 5, X-cut tape adhesion per American Society of Testing and Materials (ASTM) D3359, Method A, demonstrated that the coating had excellent adhesion (5A, no peeling or removal) to the underlying black epoxy primer.

### Example 5

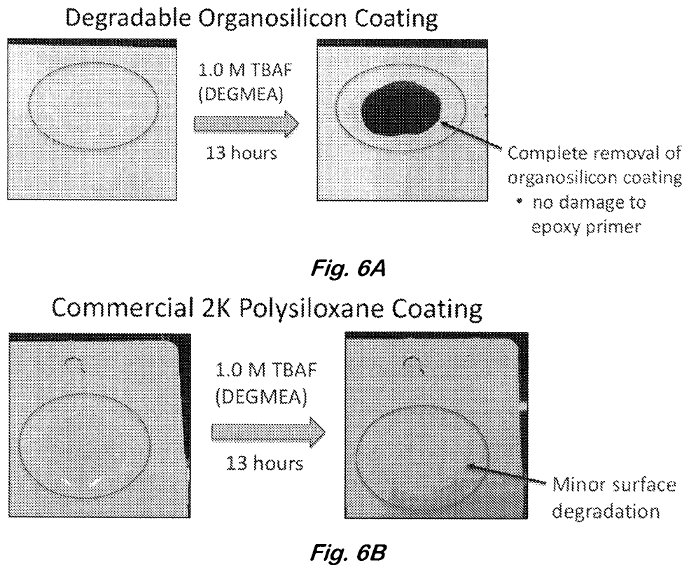

Selective removal of organosilicon network from epoxy primer using a fluoride salt solution—The semi-gloss white organosilicon coating from Example 4 was exposed to a topical application (about 5-8 drops) of 1.0 M TBAF (DEGMEA) solution at room temperature. For comparison, a commercial semi-gloss gray 2K organosilicon (a.k.a. polysiloxane) coating that is qualified to MIL-PRF-24635, Type V/VI performance requirements, and with similar thickness, was topically exposed to the same solution at room temperature. After 13 hours, the solution was removed from both samples with a tech wipe. As shown in FIG. 6A, the organosilicon coating with silyl trigger was completely degraded and removed from the underlying black epoxy primer. The primer was undamaged according to FT-IR analysis. However, as shown in FIG. 6B, only the outermost layer (about 1 micron) of the 2K polysiloxane coating was removed, likely due to minimal cleavage of Si—O linkages, thereby resulting in a spot with a duller gray color. This demonstrates that complete degradation of a cross-linked organosilicon coating occurred upon activation of the silyl trigger and subsequent cascading bond breakage of polymer chains, within the network, not simply via cleavage of Si—O linkages within the network.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A thermoset made by a process comprising:
reacting a di- or tri-functional isocyanate with a silyl-containing compound to form a polyurethane having at least one unreacted isocyanate group;
wherein the silyl-containing compound has the formula:
SiR¹ₙ[R³—(O—CO—X—R³)ₘ—OH]₄₋ₙ;
wherein each X is independently selected from —O— and —NR²—,
wherein each R¹ is independently selected from alkyl groups and aryl groups;
wherein each R² is independently selected from —H, alkyl groups, and aryl groups;
wherein each R³ is an independently selected alkylene group;
wherein n is 0, 1, or 2; and
wherein each m is an independently selected non-negative integer;
reacting the polyurethane with an aminoalkylalkoxysilane to form an alkoxysilane-terminated polyurethane; and
moisture-curing the alkoxysilane-terminated polyurethane to form the thermoset.

2. The thermoset of claim 1, wherein the silyl-containing compound is

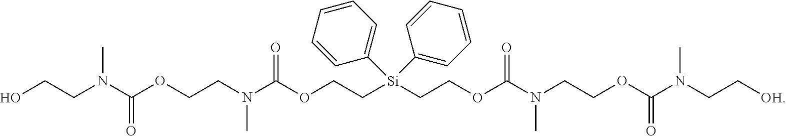 [SMILES: CN(CCO)C(=O)OCCN(C)C(=O)OCC[Si](CCOC(=O)N(C)CCOC(=O)N(C)CCO)(c1ccccc1)c1ccccc1]

3. The thermoset of claim 1, wherein the di- or tri-functional isocyanate is toluene diisocyanate, methylene diphenyl diisocyanate, hexamethylene diisocyanate, a uretdione of hexamethylene diisocyanate, a biuret of hexamethylene diisocyanate, or an isocyanurate of hexamethylene diisocyanate.

4. The thermoset of claim 1, wherein the aminoalkylalkoxysilane is N-butyl-3-aminopropyltrimethoxysilane, N-butyl-3-aminopropylmethyldimethoxysilane, or N-cyclohexyl-1-aminomethyltriethoxysilane.

5. A method comprising:
treating the thermoset of claim 1 with a solution of a fluoride salt in an organic solvent to cleave silicon-carbon and silicon-oxygen bonds in the thermoset.

6. The method of claim 5, wherein the fluoride salt is tetrabutylammonium fluoride, tetrabutylammonium difluorotriphenylsilicate, or cesium fluoride.

7. The method of claim 5, wherein method produces ethylene and carbon dioxide.

8. The method of claim 5, wherein method produces 3-methyl-2-oxazolidinone.

9. The method of claim 5, wherein method produces ethylene carbonate.

10. A method comprising:
reacting a di- or tri-functional isocyanate with a silyl-containing compound to form a polyurethane having at least one unreacted isocyanate group;
wherein the silyl-containing compound has the formula:
SiR¹ₙ[R³—(O—CO—X—R³)ₘ—OH]₄₋ₙ;
wherein each X is independently selected from —O— and —NR²—;
wherein each R¹ is independently selected from alkyl groups and aryl groups;
wherein each R² is independently selected from —H, alkyl groups, and aryl groups;
wherein each R³ is an independently selected alkylene group;
wherein n is 0, 1, or 2; and
wherein each m is an independently selected non-negative integer;
reacting the polyurethane with an aminoalkylalkoxysilane to form an alkoxysilane-terminated polyurethane; and
moisture-curing the alkoxysilane-terminated polyurethane to form a thermoset.

11. The method of claim 10, wherein the silyl-containing compound is

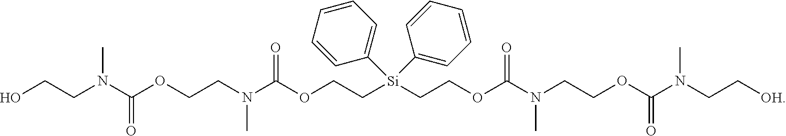 [SMILES: CN(CCO)C(=O)OCCN(C)C(=O)OCC[Si](CCOC(=O)N(C)CCOC(=O)N(C)CCO)(c1ccccc1)c1ccccc1]

12. The method of claim 10, wherein the di- or tri-functional isocyanate is toluene diisocyanate, methylene diphenyl diisocyanate, hexamethylene diisocyanate, a uretdione of hexamethylene diisocyanate, a biuret of hexamethylene diisocyanate, or an isocyanurate of hexamethylene diisocyanate.

13. The method of claim 10, wherein the aminoalkylalkoxysilane is N-butyl-3-aminopropyltrimethoxysilane, N-butyl-3-aminopropylmethyldimethoxysilane, or N-cyclohexyl-1-aminomethyltriethoxysilane.

14. The method of claim 10, further comprising:
treating the thermoset of claim 1 with a solution of a fluoride salt and an organic solvent to cleave silicon-carbon and silicon-oxygen bonds in the thermoset.

15. The method of claim 14, wherein the fluoride salt is tetrabutylammonium fluoride, tetrabutylammonium difluorotriphenylsilicate, or cesium fluoride.

16. The method of claim 14, wherein method produces ethylene and carbon dioxide.

17. The method of claim 14, wherein method produces 3-methyl-2-oxazolidinone.

18. The method of claim 14, wherein method produces ethylene carbonate.
